(19) United States
(12) Patent Application Publication
(10) Pub. No.: US 2014/0365981 A1
(43) Pub. Date: Dec. 11, 2014

(54) MOTION CONTROL OF MOBILE DEVICE

(71) Applicant: VOXER IP LLC, San Francisco, CA (US)

(72) Inventor: Matthew J. RANNEY, Oakland, CA (US)

(21) Appl. No.: 14/300,177

(22) Filed: Jun. 9, 2014

Related U.S. Application Data
(60) Provisional application No. 61/833,645, filed on Jun. 11, 2013.

(51) Int. Cl. G06F 3/01

(52) U.S. Cl. CPC G06F 3/017
USPC 715/863

(57) ABSTRACT

One aspect of the invention pertains to a method for using motion to control an application on a mobile device. Physical movement or acceleration of a mobile device is detected using a motion sensor in the mobile device. A determination is made as to whether the movement of the mobile device exceeds a predetermined toggle threshold. A feature (e.g., a recording function, a talk function, a rendering or listen function, etc.) on the mobile device is toggled or activated based on the toggle threshold determination.

### CROSS REFERENCE TO RELATED APPLICATIONS

This application claims priority to U.S. Provisional Patent Application No. 61/833,645, entitled “Motion Control of Mobile Device,” filed Jun. 11, 2013, which is incorporated herein in its entirety for all purposes.

### FIELD OF THE INVENTION

The present invention pertains to mobile applications. More specifically, the present invention pertains to methods, arrangements and systems for using a gesture (e.g., a flip gesture) to control a communications application on a mobile

### BACKGROUND OF THE INVENTION

There are a wide variety of ways to interact with mobile devices and phones. The most conventional way of interacting with a device is for a user to press a mechanical button or lever on the device. Some mobile phones include a touch sensitive, capacitive screen. Users can close, activate or interact with applications by touching icons or text that appear on the screen.

In some situations, touching a button or screen is somewhat inconvenient. As a result, some mobile devices include motion sensors or accelerometers that enable users to control their devices using gestures. An example of such an approach is the Undo function on an Apple IPHONE that is running the IOS operating system. After a user has typed, edited or cut text using the IPHONE, the user can shake the device to obtain a prompt that allows the user to undo the last action.

Although the above approaches work well for a variety of applications, there are continuing efforts to develop new ways for users to interact with mobile devices.

### SUMMARY OF THE INVENTION

Generally, the present invention relates to a telecommunication and media management system for mobile devices. More specifically, motion can be used to control a communications application on a mobile device. In one aspect, physical movement of a mobile device is detected using a motion sensor in the mobile device. A determination is made as to whether the movement of the mobile device exceeds a predetermined toggle threshold. A feature on the mobile device is then toggled based on the toggle threshold determination. In some implementations, a user can toggle a recording function, a listen/rendering function or talk feature on a mobile device simply by gesturing with the device. Thus, the user is not required to find and press a button on the device. In still other embodiments, motion in more than one dimension (e.g., a curling motion or a flip gesture rather than a motion only along one axis) is required to toggle the recording feature.

### BRIEF DESCRIPTION OF THE DRAWINGS

The invention and the advantages thereof, may best be understood by reference to the following description taken in conjunction with the accompanying drawings in which:

FIG. 1 is a block diagram of a mobile device with a motion sensor according to a particular embodiment of the present invention.

FIG. 2 is a flow diagram illustrating a method for controlling the mobile device of FIG. 1 according to a particular embodiment of the present invention.

FIG. 3 is a flow diagram illustrating a method for determining whether a motion exceeded a toggle threshold according to a particular embodiment of the present invention.

In the drawings, like reference numerals are sometimes used to designate like structural elements. It should also be appreciated that the depictions in the figures are diagrammatic and not to scale.

### DETAILED DESCRIPTION OF THE PREFERRED EMBODIMENTS

The present invention relates generally to methods and mechanisms for using motion to control an application on a mobile device. In various implementations, a user interacts with a mobile phone or other device that is capable of receiving and transmitting messages. The mobile device contains a motion sensor or accelerometer. When a user wishes to contact someone, the user can simply gesture with the device in a particular manner to activate the recording functionality of the device. If the user is receiving a call or message, the user can likewise gesture to activate the microphone of the device and respond to the call. This approach eliminates the need for a user to scrutinize the mobile device and press a particular button or icon. In addition to the above example, the present invention contemplates a wide variety of other approaches for using gestures to toggle, activate or deactivate features in a mobile device application.

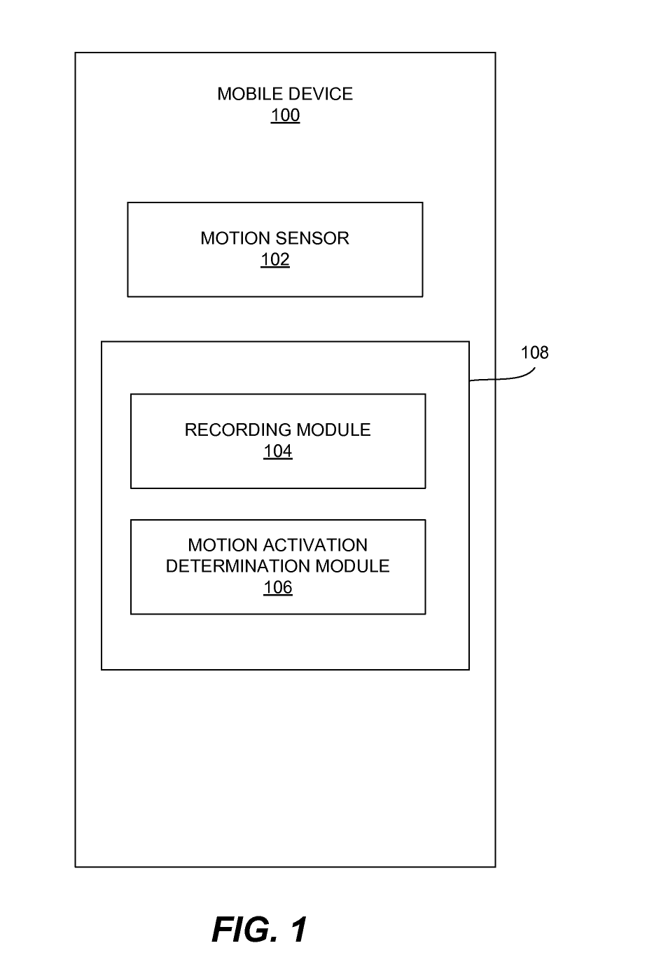

Referring initially to FIG. 1, a mobile device 100 according to a particular embodiment of the present invention will be described. The mobile device 100 includes a motion sensor 102 and a client 108. The client 108 includes a recording module 104 and a motion activation determination module 106.

The motion sensor 102 is arranged to detect motion e.g., when the mobile device 100 is shaken, swung or physically moved. In various embodiments, for example, the motion sensor is an accelerometer, although any suitable motion detecting sensor may be used. Various implementations of the motion sensor involve detecting a movement or acceleration of the device along one, two or three axes in three dimensional space (e.g., the x, y, z axes of a Cartesian coordinate system.) The motion sensor detects the motion and transmits one or more values indicating the motion to the motion activation determination module 106.

The motion activation determination module 106 receives the output of the motion sensor 102 and determines whether a particular operation should be triggered or toggled. To use a simple example, the module 106 may determine whether the mobile device 100 has been moved using a flip gesture or curling or waving motion. To make such determinations, a wide variety of motion-related algorithms may be used. Such algorithms, for example, may require a particular amount of acceleration or movement along one or more axes, require that little or no acceleration be performed along one or more axes, or any combination thereof. If the module 106 determines that the required motion has been made, the module sends a corresponding signal indicating this determination to the recording module 104.

The recording module 104 is arranged to control and monitor the activation and deactivation of a microphone, video camera or other media capturing tool on the mobile device 104. The recording module 104 receives the signal from the module 106 indicating that a user made a designated motion with the mobile device 100. In response, the module 104 then toggles a recording feature on the mobile device 100. In various embodiments, the recording feature initiates or terminates a message. For example, if the mobile device is already in a recording mode such that media is being recorded and transmitted from the device 100, then the module 104 deactivates the recording mode (e.g., shuts down a microphone or video camera used to make a call or movie.) If the mobile device is not already in a recording mode, then the recording mode is activated (e.g., media capturing tools such as a video camera and/or a microphone are activated so that media can be generated, stored and/or transmitted from the mobile device 100.)

It should be appreciated that motion can be used to control and toggle a wide variety of features on the mobile device 100, and is not necessarily limited to the toggling of a recording mode. In some embodiments, for example, a particular motion can be used to cause the motion device to emit particular sounds or alerts, display information, send media, terminate a process, terminate a connection, or any combination thereof.

The above approach works particularly well with communications and media messaging applications. The assignee of the present application has filed a variety of applications relating to a new form of media management and telecommunications system, including U.S. patent application Ser. No. 13/555/,034 (referred to herein as the '034 application) and Ser. No. 13/466,011, which are each incorporated herein in their entirety for all purposes. The aforementioned applications describe various implementations of a communications system, referred to sometimes as “Voxing,” in which a device progressively creates and sends media to another device, which progressively receives, stores and/or renders the media. Users are able to easily shift between two different modes of operation. In the first mode, users can communicate (e.g., using audio, video or some other type of media or signal) in real time or near real time. In the second, time-shifted mode, users can engage in a series of back and forth delayed transmissions. The mobile device 100 may include any feature, software or component described in connection with client 12 and device 13 of the '034 application. The motion controls described herein can be used to trigger, activate or toggle any of the features or operations described in the '034 application (e.g., mode shifts, activating the recording of a message/media, deactivating the recording of a message/media, initiating the progressive sending of a message/media to another device, etc.).

Below is one example of how motion can be used to toggle a feature in a media messaging system. Consider a situation in which a friend uses a device to call or send media (e.g., voice data) to a mobile device 100. In some embodiments, the friend progressively creates (e.g., speaks into a microphone to generate the voice data, etc.) and transmits the media to the mobile device 100. The mobile device 100 detects the incoming media and identifies the user who is sending the media. To notify the user of the mobile device 100 that someone wishes to communicate with the user, the mobile device 100 generates an audio and/or visual alert. The user then physically gestures with the mobile device 100. The motion activation determination module 106 determines that the motion meets certain criteria and sends a signal indicating this determination to the recording module 104. In response to the motion determination, the recording module activates a previously deactivated microphone or other motion capturing tool on the mobile device 100. The user records his or her voice or other media and transmits it back to the sending device. In various implementations, this response is also progressively and concurrently sent while it is being created. In this example, the user is not required to take any other action other than the aforementioned gesture to trigger the recording and/or transmitting of the media.

Consider a second situation in which a user is in the midst of recording a voice or media message for transmission to another device. The user uses a microphone or other media capturing tool on the mobile device 100 to record the media. Once the user wishes to terminate the recording of the media, rather than pressing a button on an interface of the mobile device 100, the user simply gestures with the mobile device 100. The motion sensor 102 detects the gesture and sends data regarding the gesture to the motion activation determination module 106. The module 106 analyzes the gesture data and determines that a predetermined gesture has been made. The module 106 then sends this determination to the recording module 104. In response, the recording module 104 deactivates the recording function and the media capturing tool. Again, this deactivation is performed without any further involvement or interaction with the mobile device 100 by the user. It should be appreciated that the above two scenarios describe only example implementations, and that the present invention contemplates a wide variety of different approaches to using motion to control software or hardware operations on the mobile device 100.

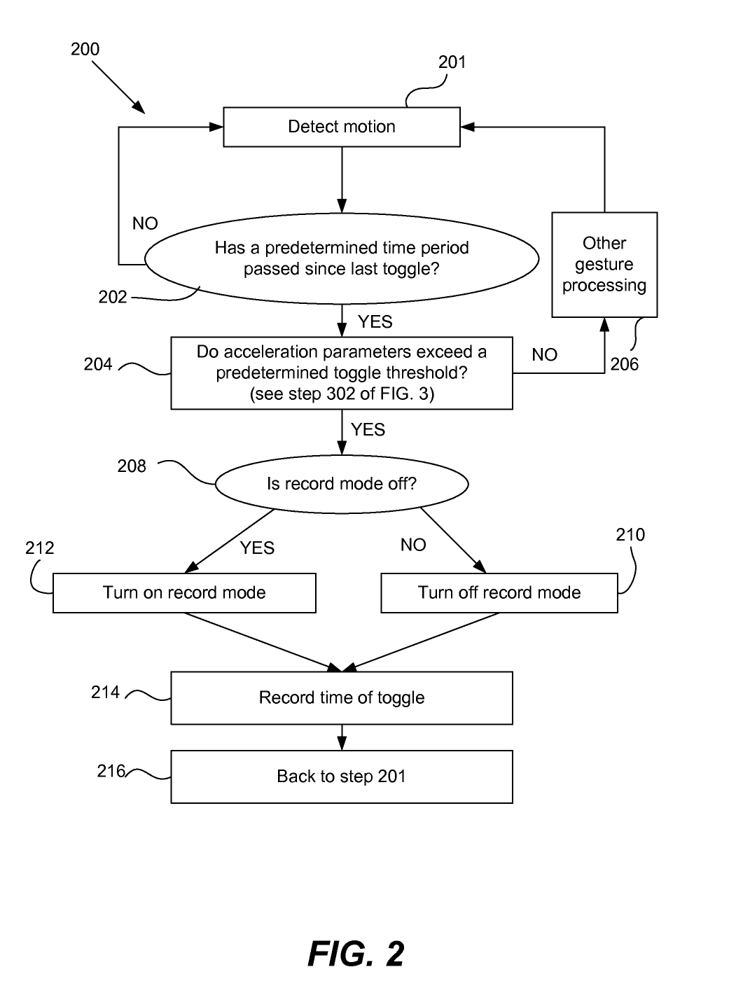

Referring next to FIG. 2, an example method for using motion to toggle a recording function on a mobile device 100 will be described. Initially, in step 201, motion sensor 102 detects physical movement of the mobile device 100. This motion may be detected using any suitable motion detector, including but not limited to an accelerometer.

At step 202, the motion activation determination module 106 determines whether a predetermined time period has passed since the last toggle of the recording feature in response to a detected motion. This step helps prevent erroneous toggling. For example, if a user makes a gesture with the mobile device 100, there is a possibility that the tail end of the gesture might be interpreted as an additional motion. If each motion triggers an activation or deactivation of a feature, then a single gesture could improperly result in a double toggle. As a result, the method 200 requires that after one motion is detected and triggers a toggle, a second toggle will not take place for a predetermined period of time. This time period may vary between different implementations. For example, a delay period of between ½ and 3 seconds works well for some applications. If the predetermined time period has not passed since the last toggle, the method 100 returns to step 201.

If the predetermined time period has passed, then the motion activation determination module 106 determines whether the acceleration parameters exceed a predetermined toggle threshold (step 204.) In other words, the module 106 analyzes the motion sensor data to determine whether a particular, designated motion (e.g., a horizontal motion, a vertical motion, a curved motion, a motion with sufficient speed or acceleration, etc.) has taken place. This determination may be performed using any suitable parameters, criteria and/or algorithms. For example, some algorithms require motion or acceleration to have taken place along one, two or three axes (e.g., such as the x, y and z axes of a Cartesian coordinate system) for the toggle threshold to be reached. Various systems require that motion or acceleration fall below a predetermined level along one, two or three axes. In one embodiment, vertical motion or acceleration is ignored or minimized in the determination of step 204 such that the up-and-down motion of the mobile device 100 in a pocket of a user does not trigger a toggle. In still another embodiment, a user must not only physically move the mobile device 100 along a particular trajectory, but most also at least partially spin or revolve the mobile device 100 at the same time.

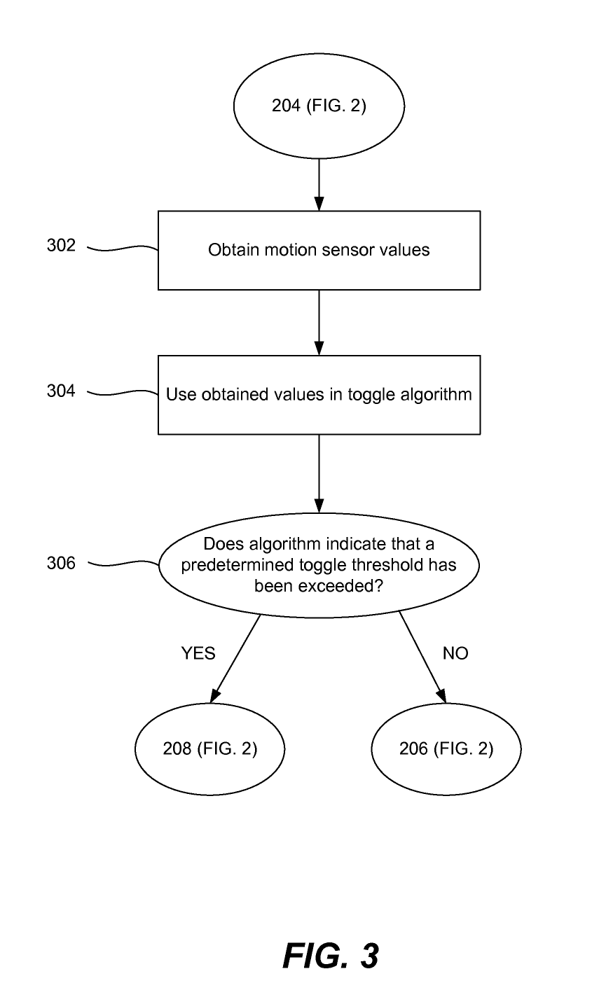

One example of a simplified process for determining whether a motion has exceeded a toggle threshold is illustrated in the flow diagram of FIG. 3. At step 302 of FIG. 3, motion sensor data is broken down into component values. In this example, Xa, Ya and Za values are obtained from the motion sensor data. Xa, Ya and Za are values that indicate acceleration along x, y and z axes, respectively, in a Cartesian coordinate system centered around a particular orientation of the mobile device 100.

In step 304, the values are used in a toggle algorithm. At step 306, the motion activation determination module 106 uses the algorithm to determine whether a toggle threshold has been exceeded. The present invention contemplates a wide variety of possible algorithms. For example, a simple example algorithm is as follows:
IF |AXₐ|+|BYₐ|+|CZₐ|>D, THEN TOGGLE THRESHOLD IS EXCEEDED
ELSE TOGGLE THRESHOLD IS NOT EXCEEDED
   A, B, C and D may be any numerical values, including zero. Depending on the values used for A, B, C and D, a wide variety of different motions can cause the toggle threshold to be exceeded. For example, consider a simple example in which A=0.5, B=0, C=1.0 and D=3. Assume further that Yₐ represents acceleration along a vertical axis y that extends along the length of the mobile device 100. As a result, vertical motion of a mobile device 100 (e.g., such as the up-and-down jostling of the mobile device 100 in a pocket) does not increase the likelihood of a toggle. A mix of motion along both the x and z axes can cause the toggle threshold to be exceeded. Additionally, a larger amount of acceleration along the x axis or a relatively smaller amount of acceleration along the z axis are individually sufficient to trigger a toggle.

Some implementations involve taking into account additional parameters other than acceleration/motion along three axes. In some embodiments, angular acceleration around one or more axes is detected and used to determine whether the toggle threshold has been exceeded. For example, the above sample algorithm can be modified as follows:
IF |AXₐ|+|BYₐ|+|CZₐ|+|EXᵣ|+|FYᵣ|+|GZᵣ|>D, THEN TOGGLE THRESHOLD IS EXCEEDED
ELSE TOGGLE THRESHOLD IS NOT EXCEEDED
   In the above example, E, F and G are any suitable numbers (including zero). X_{r,} Yᵣ and Zᵣ represent the angular rotation of the mobile device 100 around the x, y and z axes, respectively. Depending on the angular rotation values and their corresponding coefficients, rotation of a mobile device can increase the likelihood that the toggle threshold is exceeded.

Returning to FIG. 2, if the toggle threshold has not been exceeded, then other gesture processing may be implemented at step 206. For example, step 206 may involve the analysis of the motion sensor data to determine if other motions were detected, which in turn can lead to the triggering of different software or hardware applications. Afterward, the method 200 returns to step 201.

If the toggle threshold is met (meaning that a particular motion or gesture has been detected), then the motion activation determination module 106 and/or the recording module 104 determines whether record mode is already off (step 208). The record mode is then toggled. That is, if the record mode is toggled off, the record mode and any associated software or hardware (e.g., a microphone, a “talk” option in a software application, etc.) is deactivated. If the record mode is toggled on, then the record mode and any associated software/hardware is activated.

At step 214, a time of the toggle is recorded. This is later used to determine how much time has passed since the last toggle (step 202). The method 200 then repeats with step 201.

Although only a few embodiments of the invention have been described in detail, it should be appreciated that the invention may be implemented in many other forms without departing from the spirit or scope of the invention. For example, FIG. 1 illustrates particular components and modules in a mobile device. It should be appreciated, however, that the illustrated components and modules may be modified, combined, or separated in different embodiments. Any feature or operation of a particular module can be performed instead by a separate module or another of the illustrated modules. Additionally, the mobile device 100 may include a wide variety of additional features, including any module or feature described with respect to client 12 and device 13 of the '034 application. It should also be noted that the described embodiments contemplate the use of any known motion sensor data, coordinate systems or motion detection algorithms, including accelerometer data and xyz coordinate systems used in well known mobile operating systems such as IOS and ANDROID. In other words, the motion sensor data and motion detection algorithms of FIGS. 2 and 3 and paragraphs [0017] and [0018] are by no means limited to the specific examples provided therein (i.e., other values, formulas, modifiers or variables may be used, absolute values may or may not be used, etc.) Therefore, the present embodiments should be considered as illustrative and not restrictive and the invention is not limited to the details given herein, but may be modified within the scope and equivalents of the appended claims.

What is claimed is:

1. A method for using motion to control a mobile application, the method comprising:
detecting physical movement of a mobile device using one or more motion sensors in the mobile device;
determining whether the movement of the mobile device exceeds a predetermined toggle threshold; and
toggling a recording feature on the mobile device based on the toggle threshold determination wherein the recording feature is arranged to initiate or terminate a message.

2. The method as recited in claim 1 further comprising:
determining that the detected physical movement of the mobile device is a flip gesture.

3. The method as recited in claim 1, comprising:
detecting the movement of the mobile device along three axes x, y and z that represent three dimensions; and
determining whether the movement of the mobile exceeds the predetermined toggle threshold based on the movement along one or more of the axes.

4. The method as recited in claim 3 wherein the movement of the mobile device along one of the x, y and z axes is substantially irrelevant in determining whether the toggle threshold has been exceeded.

5. The method as recited in claim 1 further comprising:
measuring acceleration of the mobile device; and
using the measured acceleration of the mobile device to help determine whether the predetermined toggle threshold is exceeded.

6. The method as recited in claim 1 further comprising:
measuring angular rotation of the mobile device around one or more axes; and
using the measured angular rotation of the mobile device to help determine whether the predetermined toggle threshold is exceeded.

7. The method as recited in claim 1, comprising:
receiving an audio message at the mobile device;
alerting a user of the mobile device about the incoming message, wherein the physical movement of the mobile device enables the user to review the message or respond using a microphone on the mobile device.

8. The method as recited in claim 1, wherein the physical movement of the mobile device causes the predetermined toggle threshold to be exceeded, the method further comprising:
in response to the physical movement, activating a microphone or video camera on the mobile device;
receiving input from a user and the microphone or video camera to prepare a media message; and
transmitting the media message from the mobile device to another device over a network.

9. The method as recited in claim 1 further comprising:
determining whether a predetermined amount of time has passed since a last time that the state of the feature was changed; and
if the predetermined amount of time has not passed, not performing the determination and toggling operations until the predetermined amount of time has passed.

10. The method as recited in claim 1 wherein the mobile device comprises at least one selected from the group consisting of: a land-line phone, a wireless phone, a mobile phone, a computer, a radio, a satellite phone, a satellite radio, a tactical radio, and a tactical phone.

11. The method as recited in claim 1 wherein the toggling of the recording feature involves at least one selected from the group consisting of activating a microphone on the mobile device, deactivating a microphone on the mobile device, activating an application on the mobile device, deactivating an application on the mobile device, transmitting a message from the mobile device and rendering a message received at the mobile device.

12. The method as recited in claim 1 wherein the toggling of the recording feature is triggered by the physical movement and does not require any other interaction between a user and the mobile device.

13. A mobile device that is capable of being controlled using motion, the mobile device comprising:
a motion sensor that is arranged to detect physical movement of a mobile device;
a motion activation determination module that is arranged to determine whether the movement of the mobile device exceeds a predetermined toggle threshold; and
a recording module that is arranged to toggle a recording feature on the mobile device based on the toggle threshold determination wherein the recording feature is arranged to initiate or terminate a message.

14. The mobile device as recited in claim 13 wherein the motion activation determination module is further arranged to determine whether the detected physical movement of the mobile device is a flip gesture.

15. The mobile device as recited in claim 13 wherein the motion activation determination module is further arranged to:
detect the movement of the mobile device along three axes x, y and z that represent three dimensions; and
determine whether the movement of the mobile exceeds the predetermined toggle threshold based on the movement along one or more of the axes.

16. The mobile device as recited in claim 15 wherein the movement of the mobile device along one of the x, y and z axes is substantially irrelevant in determining whether the toggle threshold has been exceeded.

17. The mobile device as recited in claim 13 wherein the motion activation determination module is further arranged to:
determine acceleration of the mobile device; and
use the acceleration of the mobile device to help determine whether the predetermined toggle threshold is exceeded.

18. The mobile device as recited in claim 13 wherein the motion activation determination module is further arranged to:
determine angular rotation of the mobile device around one or more axes; and
use the angular rotation of the mobile device to help determine whether the predetermined toggle threshold is exceeded.

19. The mobile device as recited in claim 13 wherein the mobile device further comprises:
a network receiver arranged to receive an audio message at the mobile device;
an interface that is arranged to alert a user of the mobile device about the incoming message, wherein the physical movement of the mobile device enables the user to review the message or respond using a microphone on the mobile device.

20. The mobile device as recited in claim 13 wherein the mobile device comprises at least one selected from the group consisting of: a land-line phone, a wireless phone, a mobile phone, a computer, a radio, a satellite phone, a satellite radio, a tactical radio, and a tactical phone.

21. The mobile device as recited in claim 13 wherein the toggling of the recording feature is triggered by the physical movement and does not require any other interaction between a user and the mobile device.

22. A computer code embedded in a non-transitory computer readable medium and intended to run on a mobile device connected to a network, the computer code configured to:
detect physical movement of a mobile device using a motion sensor in the mobile device;
determine whether the movement of the mobile device exceeds a predetermined toggle threshold; and
toggle a recording feature on the mobile device wherein the recording feature is arranged to initiate or terminate a message.

23. The computer code as recited in claim 22, the computer code being further configured to determine that the detected physical movement of the mobile device is a flip gesture.

24. The computer code as recited in claim 22, the computer code being further configured to:
detect the movement of the mobile device along three axes x, y and z that represent three dimensions; and
determine whether the movement of the mobile exceeds the predetermined toggle threshold based on the movement along one or more of the axes.

25. The computer code as recited in claim 24 wherein the movement of the mobile device along one of the x, y and z axes is substantially irrelevant in determining whether the toggle threshold has been exceeded.

26. The computer code as recited in claim 22, the computer code being further configured to:
measure acceleration of the mobile device; and
use the measured acceleration of the mobile device to help determine whether the predetermined toggle threshold is exceeded.

27. The computer code as recited in claim 22, the computer code being further configured to:
measure angular rotation of the mobile device around one or more axes; and
use the measured angular rotation of the mobile device to help determine whether the predetermined toggle threshold is exceeded.

28. The computer code as recited in claim 22, the computer code being further configured to:
receive an audio message at the mobile device;
alert a user of the mobile device about the incoming message, wherein the physical movement of the mobile device enables the user to review the message or respond using a microphone on the mobile device.

29. The computer code as recited in claim 22 wherein the physical movement of the mobile device causes the predetermined toggle threshold to be exceeded, the computer code being further arranged to:
in response to the physical movement, activate a microphone or video camera on the mobile device;
receive input from a user and the microphone or video camera to prepare a media message; and
transmit the media message from the mobile device to another device over a network.

30. The computer code as recited in claim 22, the computer code being further configured to:
determine whether a predetermined amount of time has passed since a last time that the state of the feature was changed; and
if the predetermined amount of time has not passed, not perform the determination and toggling operations until the predetermined amount of time has passed.

31. The computer code as recited in claim 22 wherein the toggling of the recording feature involves at least one selected from the group consisting of activating a microphone on the mobile device, deactivating a microphone on the mobile device, activating an application on the mobile device, deactivating an application on the mobile device, transmitting a message from the mobile device and rendering a message received at the mobile device.

32. The computer code as recited in claim 22 wherein the toggling of the recording feature is triggered by the physical movement and does not require any other interaction between a user and the mobile device.

33. The method for using motion to control a mobile application, the method comprising:
receiving a media message at a mobile device;
alerting a user of the mobile device about the incoming message;
detecting physical movement of the mobile device using one or more motion sensors in the mobile device;
determining whether the movement of the mobile device exceeds a predetermined threshold; and
rendering the media message for review by the user wherein the physical movement of the mobile device and the exceeding of the predetermined threshold causes the rendering of the media message.

34. The method for using motion to control a mobile application, the method comprising:
receiving a media message at a mobile device;
alerting a user of the mobile device about the incoming message;
detecting physical movement of the mobile device using one or more motion sensors in the mobile device;
determining whether the movement of the mobile device exceeds a predetermined toggle threshold; and
activating a previously deactivated microphone on the mobile device, thereby enabling the user to respond to the incoming message wherein the physical movement of the mobile device and the exceeding of the toggle threshold causes the activation of the microphone.
